(19) United States
(12) Patent Application Publication
(10) Pub. No.: US 2016/0063973 A1
(43) Pub. Date: Mar. 3, 2016

(54) Device and Method for Tuning a Drum Pedal Assembly

(71) Applicant: Blake Lemieux, Saint Eustache (CA)

(72) Inventor: Blake Lemieux, Saint Eustache (CA)

(21) Appl. No.: 14/591,670

(22) Filed: Jan. 7, 2015

Related U.S. Application Data
(63) Continuation of application No. 61/924,264, filed on Jan. 7, 2014.

(51) Int. Cl. G10D 13/00

(52) U.S. Cl. CPC G10D 13/006

(57) ABSTRACT

A device for tuning a drum pedal assembly. The device is a rod, a weight with an aperture that is slidably mountable on the rod, and a means for fastening the weight in position along the rod. The present device can be used to tune a drum pedal assembly by setting the spring tension on the drum assembly according to user preference, removing the mallet shaft from the mallet base, attaching a rod and one or more slidable weights to the rod, moving the one or more weights along the rod until the rod reaches a desired reference position with respect to the pedal base, locking the one or more weights in position along the rod, and removing the combined rod and weight assembly from the mallet base is also provided.

### CROSS REFERENCE TO RELATED APPLICATION

This application claims the benefit of U.S. Provisional Application No. 61/924,264, filed on Jan. 7, 2014. The above identified patent application is herein incorporated by reference in its entirety to provide continuity of disclosure.

### FIELD OF THE INVENTION

The present invention relates to a device and method for tuning a drum pedal assembly.

### BACKGROUND OF THE INVENTION

Drum kits enable users to play more than two percussion instruments simultaneously by means of one or more foot pedals. Drum pedal assemblies are well known in the art. Generally, these assemblies comprise a pedal base, a pedal, a drive mechanism such as a drive shaft, chain and cam, and a striking element that strikes the drum when the pedal is actuated. Standard drum pedals also comprise a means for adjusting the response and feel of the pedal. An adjustable spring is fixedly attached between the drive shaft and the pedal base. The spring acts on the drive shaft when the user depresses the pedal, causing the pedal to exert an additional force against the user's foot.

Users may adjust the tension of the spring to suit their playing style. A tighter spring tension causes the pedal to exert a stronger force against the player's foot. This causes the pedal to be in constant contact with the user's foot, allowing for quick pedal response and faster playing. A looser spring tension causes the pedal to exert less force against the user's foot. A loose spring tension also provides more precise control over the pedal position and allows for a higher variation of tone and sound.

Individual users have unique spring tension settings that are dependent on play style. Users typically employ a trial and error process to set the spring tension on a drum pedal assembly, alternating between adjusting the spring tension and actuating the pedal until the desired response is achieved. One problem with typical drum pedal assemblies is that this trial and error process must be repeated for each individual pedal one uses. Tinkering with the spring tension is an inefficient and time consuming process. A method for tuning a drum pedal assembly that is applicable to any standard drum pedal assembly is therefore desired.

Another problem inherent in typical drum pedal assemblies is that the spring tension loosens over time, especially if the drum pedal experiences frequent use. A user must repeat the aforementioned trial and error process for the user's other drum pedals or when using an unfamiliar pedal. This process must also be repeated on the user's primary pedal once the user feels the spring tension loosening. Due to variances between different brands of drum pedal assemblies, a user is unable to tell if the spring tension in another pedal is the same as the spring tension in the user's primary pedal. Therefore, a device that provides a reference for the spring tension of a drum pedal assembly is desired.

Devices exist in the prior art that function to add weights to drum pedal mallet assemblies. This and similar devices in the prior art generally are designed to provide a means for further fine tuning a drum pedal assembly by using weight to change the swing speed of the mallet element. However, these devices introduce another parameter to the tuning process, further increasing the difficulty of tuning multiple pedals. These devices also fail to address the problem of the spring tension loosening over time with repeated use.

Other devices exist in the prior art that are similar to traditional drum pedal assemblies but with additional pedal weight adjustment features. Users adjust the weight of the foot pedal itself in order to further fine tune the pedal response. One disadvantage of drum pedals with adjustable pedal weights is that the adjustment system and the pedal assembly are integrated, meaning the adjustment system cannot be used with standard drum pedal assemblies. Therefore, a device that can be used to tune any standard drum pedal is desired.

### SUMMARY OF THE INVENTION

In view of the foregoing disadvantages inherent in the known types of drum pedal assemblies now present in the prior art, the present invention provides a method and device for tuning a drum pedal assembly that can be utilized for providing for convenience for the user when adjusting the spring tension on a drum pedal assembly.

It is an object of the present invention to provide a method for tuning a drum pedal assembly. First, a user sets the desired spring tension on a first drum pedal assembly having a spring, a mallet shaft, a mallet base, and a pedal base. The user then removes the mallet shaft from the mallet base, attaches a rod to the mallet base, attaches one or more slidable weights to the rod, and moves the one or more weights until the rod reaches a desired reference position with respect to the pedal base. Then, the user locks the one or more weights into position along the rod, forming a rod and weight assembly.

It is a further object of the present invention to provide a device for tuning a drum pedal assembly whose spring tension of which has loosened over time, wherein the user may remove the mallet shaft from the mallet base, reattach the previously set tuning device, and readjust the tension of the spring until the rod and weight return to the reference position previously defined by the user. Once the rod returns to the reference position, which indicates that the spring tension is reset to the user's original preference, the device may be removed from the mallet base and replaced with the mallet shaft and mallet hammer.

Another object of the present invention is to provide a method for tuning a drum pedal assembly wherein the reference position of the rod is such that the rod is parallel to the pedal base.

Yet another object of the present invention is to provide a method for tuning a drum pedal assembly with the additional steps of removing a second mallet shaft from a second drum pedal assembly having a second spring, a second mallet shaft, a second mallet base, and a second pedal base, attaching the rod and weight assembly to the second mallet base, adjusting the spring tension on the second spring until the rod reaches the reference position, and removing the rod and weight assembly from the second mallet base.

Still another object of the present invention is to provide a drum pedal tuning device having a rod, a weight with an aperture that is slidably mountable on the rod, and a means for fastening the weight in position along the rod.

A further object of the present invention is to provide a drum pedal tuning device wherein the means for fastening the weight in position along the rod includes a square drum screw.

### BRIEF DESCRIPTIONS OF THE DRAWINGS

FIG. 1 is a perspective view of a standard drum pedal assembly.

FIG. 2A is a side view of a preferred embodiment of the present invention showing the weight element off of the rod element.

FIG. 2B is a side view of a preferred embodiment of the present invention showing the weight element slid along the rod element.

FIG. 3 is a side view of a preferred embodiment of the present invention showing the rod element attached to a standard drum pedal assembly.

FIG. 4 is a side view of a preferred embodiment of the present invention showing both the rod and weight elements attached to a standard drum pedal assembly.

### DETAILED DESCRIPTION OF THE INVENTION

Reference is made herein to the attached drawings. Like reference numerals are used throughout the drawings to depict like or similar elements of the present invention. For the purposes of presenting a brief and clear description of the present invention, the preferred embodiment will be discussed as used for tuning a drum pedal. The figures are intended for representative purposes only and should not be considered to be limiting in any respect.

The present invention relates to a device used for tuning drum pedal assemblies. The device attaches to a drum pedal assembly in place of a mallet shaft. The device is adjustable, allowing users to save a particular spring tension and apply the device and accompanying method for tuning a drum pedal assembly to multiple drum pedal assemblies in order to replicate the saved spring tension from the first drum pedal assembly. The following description details the interaction between the present invention and drum pedal assemblies.

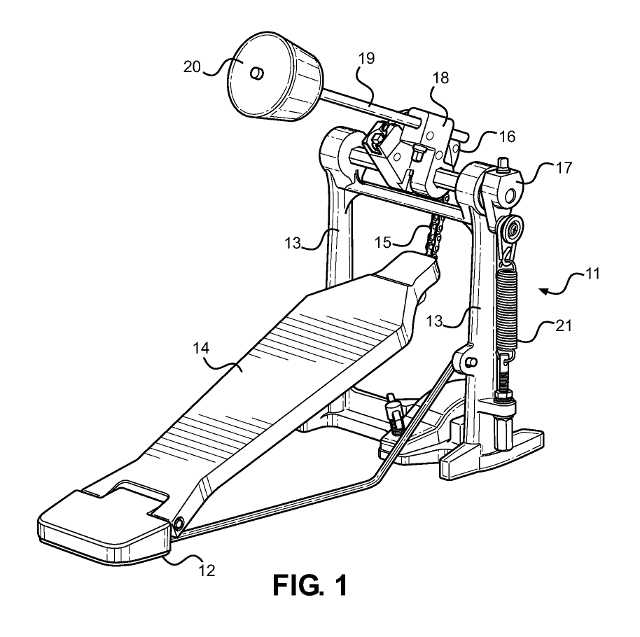

FIG. 1 depicts a drum pedal assembly 11. The pedal assembly comprises a pedal base 12 with two vertical support pillars 13 and a foot pedal 14 pivotally attached at one end to the pedal base 12. A drive mechanism 15, depicted here as a chain, attaches to the free end of the foot pedal 14 at one end and to a cam 16, which is mounted to the drive shaft 17, at the other end. The drive shaft 17 is rotatably mounted between the two support pillars 13. A mallet base 18 is fixedly attached to the drive shaft 17. A mallet shaft 19 is slidably and removably mounted within the mallet base 18 and extends axially from the drive shaft 17. A mallet head 20 is connected to the mallet shaft 19. To operate the drum pedal, a user depresses the foot pedal 14 causing the drive shaft 17 to rotate, which in turn causes the mallet head 20 to strike a drum, which is omitted from this figure.

The pedal assembly also includes an adjustable spring 21, which is fixedly attached to the base 12 at one end and to the drive shaft 17 at the other end. When the user depresses the foot pedal 14, the adjustable spring 21 exerts a torque on the drive shaft 17, which acts to return the foot pedal 14 to an unactuated position. Users may adjust the tension of the spring 21 to suit their playing style. A loose spring tension lessens the force of the pedal against the user's foot, which in turn allows for finessed playing and controlled volume. Conversely, a tight spring tension increases the force of the pedal against the user's foot, which allows for quicker pedal response and faster playing while sacrificing some of the volume control that is possible with a looser spring tension.

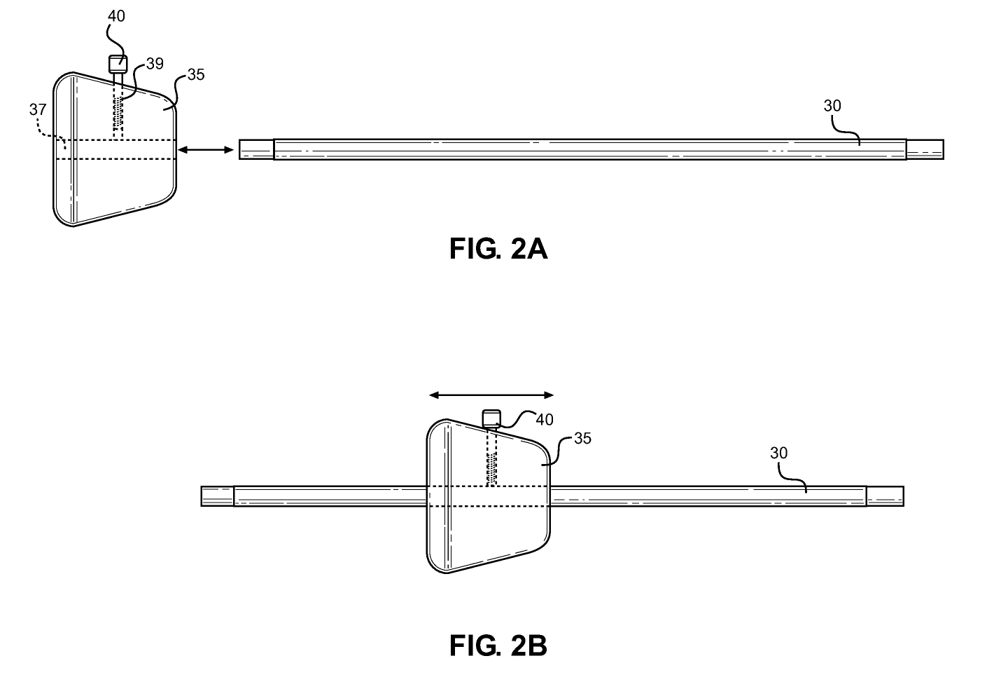

FIG. 2A depicts a side view of one embodiment of the present invention showing the rod and weight elements separate. The device comprises a rod 30 and one or more weights 35. The weight 35 is depicted here as a single weight element but multiple weight elements may be used. The rod 30 is slidably mountable to the mallet base of a standard drum pedal assembly and can be locked in place to the mallet base using a set screw, such as a square drum screw. The weight 35 has an aperture 37 in the center which runs the length of the weight 35, enabling the weight 35 to be slidably mountable on the rod 30. The weight 35 can move freely to any position along the length of the rod 30.

The weight 35 also has a threaded aperture 39 and a set screw 40, which provides a means for securing the weight in a desired position along the rod 30 so that the weight can no freely longer slide along the rod. Means for securing the weight 35 includes, but is not limited to, a standard square drum screw which may be tightened or loosened with a standard drum key.

FIG. 2B depicts a side view of one embodiment of the present invention showing the weight element fastened along the rod element. When the set screw 40 is tight against the rod 30, the weight 35 is locked in position and may no longer be moved along the rod 30. In the depicted embodiment of the present invention, the threaded aperture 39 is disposed orthogonally relative to the aperture 37; however, the threaded aperture 39 can be disposed at any angle relative to the aperture 37 that allows the set screw 40 to extend through the weight 35 and make contact with the rod 30.

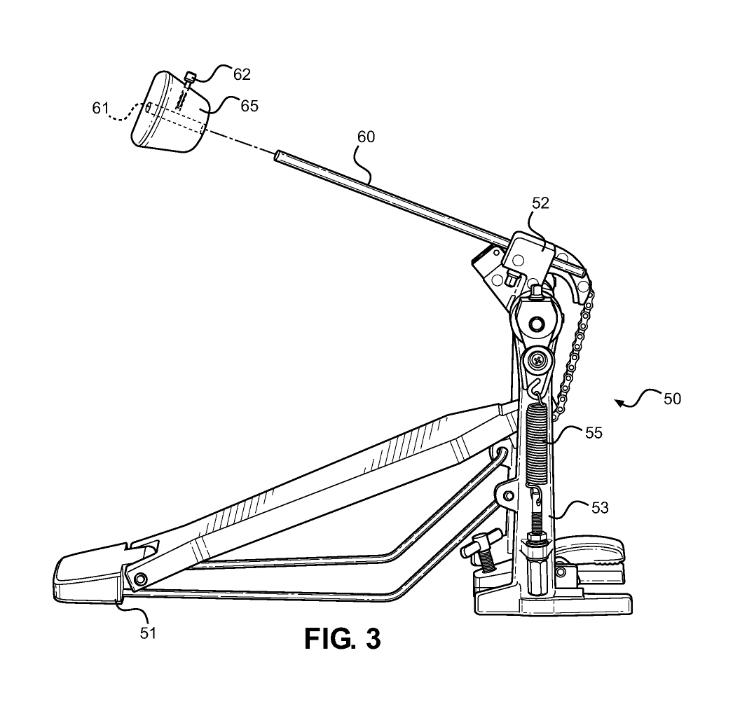

FIG. 3 is a side view of a standard drum pedal assembly with the rod portion of the present invention attached. The drum pedal assembly 50 comprises a pedal base 51, a mallet base 52, two vertical support pillars 53, only one of which is visible in this diagram, and an adjustable spring 55, the tension of which has previously been set according to a user's preference. The mallet shaft has been removed and replaced with rod 60, which removably attaches to mallet base 52. Weight 65, which has an aperture 61 and fastening mechanism 62, may then be slidably mounted on rod 60.

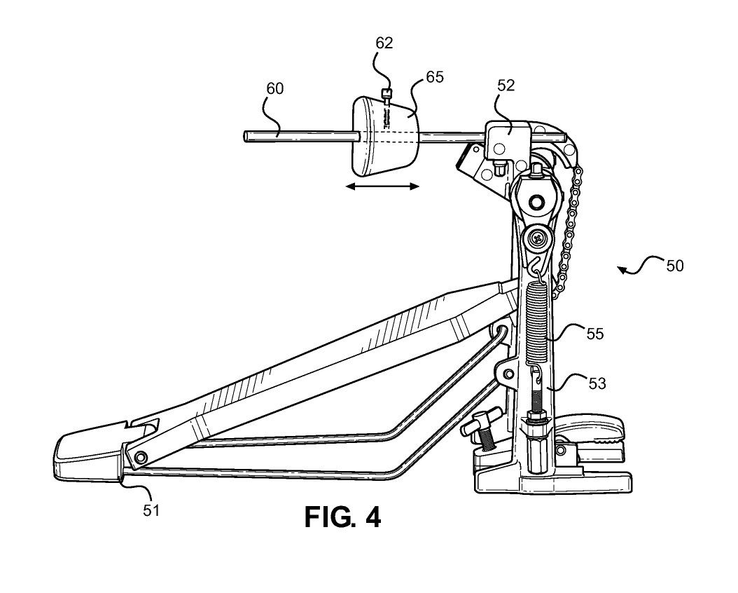

FIG. 4 is a schematic depiction of the same standard drum pedal assembly depicted in FIG. 3 but with both the rod and weight elements of the present invention attached. In order to tune a drum pedal assembly using a device according to the present invention, a user first sets the spring tension on a drum pedal assembly to his or her desired tension. The user then removes the mallet shaft from mallet base 52 and attaches rod 60 to mallet base 52.

After weight 65 is mounted on rod 60, the user may select a reference position for rod 60 with respect to support pillars 53. The user slides weight 65 along rod 60 until rod 60 reaches the desired reference position. The reference position of rod 60 as depicted in FIG. 4 is such that rod 60 is balanced horizontally and is parallel to pedal base 51. This particular reference position is preferable because the position of the horizontally-balanced rod is easy to replicate across multiple pedals, but a user may select any replicable reference position as desired. Once rod 60 is in the desired reference position, the user fastens weight 65 in place on rod 60 using set screw 62. The user may now remove the combined weight and rod device from mallet base 52 and replace it with the mallet shaft and mallet hammer originally attached to mallet base 52.

When the tension in spring 55 loosens over time, the user may remove the mallet shaft from mallet base 52, reattach the tuning device, which comprises rod 60 and previously fastened weight 65, and readjust the tension of spring 55 until the rod and weight return to the reference position previously defined by the user. Once the rod returns to the reference position, which indicates that the spring tension is reset to the user's original preference, the device may be removed from mallet base 52 and replaced with the mallet shaft and mallet hammer.

The foregoing example applies to any standard drum pedal. The user may attach the present device to the mallet base of any standard drum pedal and adjust the spring tension until the rod portion of the device reaches the reference position determined previously, ensuring that the spring tension in any pedal will match the spring tension in the user's primary pedal.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method of tuning a spring tension setting of a drum pedal assembly having a spring, a mallet shaft, a mallet base, and a pedal base, comprising the steps of:
removing the mallet shaft from the mallet base;
attaching a rod to the mallet base;
attaching a slidable weight to the rod;
moving the weight along the rod until the rod reaches a reference position;
locking the weight in place on the rod to form a rod and weight assembly;
wherein the reference position corresponds to a desired tension of the spring.

2. The method of tuning a drum pedal assembly of claim 1, further comprising the steps of:
removing the rod and weight assembly;
reattaching the mallet shaft to the mallet base.

3. The method for tuning a drum pedal assembly of claim 2, further comprising the steps of:
removing mallet shaft from the mallet base when the spring no longer has the desired tension;
attaching the rod and weight assembly to the mallet base;
adjusting the spring tension on the spring until the rod reaches the reference position.

4. The method of claim 1, wherein the reference position of the rod is such that the rod is parallel to the pedal base.

5. The method of claim 1, further comprising the steps of:
removing a second mallet shaft from a second drum pedal assembly having a second spring, a second mallet shaft, a second mallet base, and a second pedal base;
attaching the rod and weight assembly to the second mallet base;
adjusting the spring tension on the second spring until the rod reaches the reference position;
removing the rod and weight assembly from the second mallet base.

6. A drum pedal tuning device, comprising
a rod;
a weight with an aperture that is slidably mountable on the rod;
a means for fastening the weight in place on the rod.

7. The device of claim 4, wherein the means for fastening the weight in place on the rod comprises a square drum screw.
